(19) United States
(12) Patent Application Publication
(10) Pub. No.: US 2022/0275793 A1
(43) Pub. Date: Sep. 1, 2022

(54) SWITCHING DEVICE FOR A CONCRETE PUMP

(71) Applicant: Putzmeister Engineering GmbH, Aichtal (DE)

(72) Inventors: Andreas Kandler, Ostfildern (DE); Andreas Benz, Wendlingen (DE)

(21) Appl. No.: 17/631,574

(22) PCT Filed: Jul. 30, 2020
(86) PCT No.: PCT/EP2020/071470

§ 371 Date: Jan. 31, 2022

(30) Foreign Application Priority Data
Aug. 1, 2019 (DE) 10 2019 120 825.4

(51) Int. Cl. F04B 15/02

(52) U.S. Cl. CPC F04B 15/023

(57) ABSTRACT

A switching device for switching a hydraulic flow of a concrete pump, comprising a first connection component for connection to a hydraulic pump; a second connection component for connection to a drive cylinder; and a distribution unit which is arranged between the first and second connection components, wherein the first connection component has two fluid guides and the second connection component has a first fluid-guide pair and a second fluid-guide pair, and the distribution unit can be transferred reversibly between a first position, in which the fluid guides of the first connection component are connected fluidically to the first fluid-guide pair of the second connection component, and a second position, in which the fluid guides of the first connection component are connected fluidically to the second fluid-guide pair of the second connection component.

### BACKGROUND

The invention relates to a switching device for switching a hydraulic flow of a concrete pump, and to a concrete pump. The invention furthermore relates to a method for switching a hydraulic flow of a concrete pump.

The use of switching devices for switching a hydraulic flow in concrete pumps allows a flexible transfer of the drive side between the rod side and the bottom side of a drive cylinder. Rod-side or bottom-side operation of concrete pumps is realized depending on the application, wherein, as standard, the drive cylinders are driven at the rod side. However, bottom-side operation of the drive cylinders is readily possible if the rest of the components of the concrete pump and the pressure-medium lines are designed for this.

In the case of a drive cylinder driven at the rod side, relatively large amounts of concrete for conveyance can be conveyed due to the relatively quick stroke times. In the case of a drive cylinder driven at the bottom side, a relatively large conveying pressure for concrete can be attained at the maximum available hydraulic oil pressure since the large bottom side of the drive cylinder is used.

If, in the case of a rod-side operation, the maximum delivery head has been attained, an operator can switch the concrete pump to bottom-side operation so as to increase the maximum delivery head and, in this way, to reach higher levels. Moreover, an operator can switch the concrete pump from bottom-side operation to rod-side operation if a greater conveyance amount is required. In the latter case, quick switching of the operating mode is important in order for the concrete in the concrete line not to harden.

The prior art has disclosed rod/bottom-switching devices in the case of which large and inflexible pressure hoses have to be dismounted and remounted again at a different position. During the remounting of the pressure hoses, hydraulic oil can escape or impurities can pass into the system. Furthermore, the accessibility to the pressure hoses within the machine is in part possible only to a limited extent, with the result that extra longer/additional pressure hoses have to be routed to the outside to the connection points. This requires a high outlay in terms of time and assembly and is moreover susceptible to error.

### SUMMARY OF THE INVENTION

The invention is based on the object of providing a switching device which is improved in relation to the prior art.

This object is achieved by a switching device as claimed in the main claim, a concrete pump as claimed in claim 16, and a method for switching a hydraulic flow of a concrete pump as claimed in claim 17.

Accordingly, the invention relates to a switching device for switching a hydraulic flow of a concrete pump, having a first connection component for connection to a hydraulic pump, having a second connection component for connection to a drive cylinder, and having a distribution unit which is arranged between the first and second connection components. The first connection component has two fluid guides, and the second connection component has a first and a second fluid-guide pair. The distribution unit can be transferred reversibly between a first position, in which the fluid guides of the first connection component are connected fluidically to the first fluid-guide pair of the second connection component, and a second position, in which the fluid guides of the first connection component are connected fluidically to the second fluid-guide pair of the second connection component, and the distribution unit is connected in a leak-tight manner to the first and second connection components.

The invention is based on the realization that, through the transfer of the distribution unit between the first and second positions alone, a fluid flow for actuating a drive cylinder is redirected without the first and second connection components, and possibly further fluid guides connected thereto, having to be moved or remounted. The switching device according to the invention consequently allows switching from rod-side operation to bottom-side operation and vice versa within a very short period of time without additional outlay in terms of assembly or the use of specially trained personnel.

A few expressions will firstly be explained.

A fluid guide is to be understood as meaning any type of fluid line which is suitable for guiding a fluid, such as a pressurized hydraulic medium. In the simplest form, the fluid guide is a bore which functions, for example, as a pressure-medium line. Fluid guide also refers to flexible or less flexible pressure hoses. The expression fluid-guide pair is to be understood in a functional sense and describes two fluid guides which are separated from one another but are connected for a common purpose.

A connection component may have any desired form and is configured in such a way that it accommodates one or more fluid guides. The connection components form the outer part of the switching device and may have ports for pressure-medium hoses. It is possible for the connection components to be configured as connection plates, or connection blocks, which possibly provide on an outer side fixedly mounted ports for pressure-medium hoses.

A distribution unit is arranged between the connection components. Said distribution unit may likewise have any desired form, it being advantageous however for the distribution unit to bear in a flush manner against the first and second connection components. The distribution unit can then be fixed between the connection components in a sandwich-type structure. The distribution unit is configured for selectively producing a fluid connection between fluid guides of the first and second connection component. For this purpose, the distribution unit may likewise have fluid guides.

A reversible transfer of the distribution unit between a first and a second position is to be understood as meaning any change in the position or orientation of the distribution unit. The transfer may be carried out manually, electrically, hydraulically or pneumatically.

In the first position of the distribution unit, the fluid guides of the first connection component are connected fluidically to the first fluid-guide pair of the second connection component. In the second position of the distribution unit, the fluid guides of the first connection component are connected fluidically to the second fluid-guide pair of the second connection component. In both cases, a fluid can be transferred to a drive cylinder via the switching device, albeit via different outlets. The switching from a first fluid-guide pair to a second fluid-guide pair makes it possible for example for the drive side to be transferred from the rod side to the bottom side of the drive cylinders.

The invention makes possible switching of the hydraulic flow by way of simple mechanical means, in particular without the use of costly hydraulic and electrical valves. Furthermore, a position of the connection components remains unchanged when the hydraulic flow is switched. This has the advantage that complete unscrewing or turning is unnecessary for any of the connection components and components connected thereto. Consequently, during the switching, no hydraulic oil can escape, and also no impurities can pass into the hydraulic system, since the fluid guides are not freely accessible.

Preferably, the distribution unit can be transferred between the first and second positions by way of rotation or translation. Here, the distribution unit preferably rotates about a central axis or is displaced laterally. The transfer may be realized manually by an operator or electrically and is reversible.

Furthermore preferably, when the distribution unit is transferred between the first and second positions, a position of the first and second connection components is not changed. The stationary connection components, together with any fluid guides connected thereto (for example pressure hoses), are consequently not influenced by the switching and do not have to be designed accordingly.

In an advantageous embodiment, the distribution unit has a first sealing surface for interaction with a sealing surface of the first connection component and/or has a second sealing surface for interaction with a sealing surface of the second connection component. The interaction of the sealing surfaces ensures that, during the switching, the switching device is leak-tight (even in the case of high pressures in the fluid guide). The sealing surfaces may be formed by seal rings (for example O-rings).

The first and second connection components may be connected to one another in a resilient manner such that it is ensured that, during the switching process, no fluid escapes between gaps between the distribution unit and the connection components.

The first and second connection components may be connected to one another via at least one releasable fastening means. The fastening means may for example be a screw. In this way, the connection components may be fixed to one another in such a way that they clamp the distribution unit between them. A clamping force between the connection components acting on the distribution unit may be set via the fastening means. During the operation of the hydraulic pump, the fastening means should fix the connection components firmly, while, during a transfer of the distribution unit, the fastening means should be loosened slightly, so that the distribution unit has a degree of play. Owing to the geometry of the switching device, it may be advantageous to use multiple fastening means in a symmetrical arrangement, in order to achieve a homogeneous distribution of the forces.

The first and second connection components may be connected to one another via a resiliently mounted fastening element in such a way that the distribution unit is connected in a leak-tight manner to the first and second connection components. For example, through the use of a spring with a known spring constant, the connection plates are held together by a force at all times, which ensures that no fluid can escape between the respective connection component and the distribution unit. This is particularly important if the fastening means is loosened slightly, in order to transfer the distribution unit into another position, but at the same time the fluid guides are filled with fluid and an escape thereof is to be avoided. The expression resiliently mounted fastening element is to be understood as meaning any type of connecting means which ensures a resiliently sealed connection of the connection components to the distribution unit. The fastening element could thus, for example, also be configured as a spacer which ensures that, when the fastening element is opened, only a defined gap between connection components and distribution unit can result, this being compensated by corresponding (resilient) seals.

In an advantageous embodiment, the fastening means and/or the resiliently mounted fastening element are/is configured as a guide aid for the transfer of the distribution unit. The fastening means and/or the resiliently mounted fastening element may for example predefine a central axis about which the distribution element rotates. For this purpose, the fastening means and/or fastening element are/is guided through a cutout in the distribution unit. The cutout may also be in the form of a slot which allows a lateral displacement of the distribution unit along the slot.

The first and/or second connection component may have a guide element for the transfer of the distribution unit between the first and second positions. The guide element may for example be in the form of a groove into which a projection of the distribution unit engages, or the other way round. The groove may extend for example with an offset shape, circularly or rectilinearly.

Preferably, the switching device is designed in such a way that the distribution unit has an operating lever for the transfer between the first and second positions. Furthermore preferably, the operating lever interacts with a guide element of the first or second connection component. Via the operating lever, an operator can manually for example rotate or displace the distribution unit. For this purpose, the operating lever can be guided through a cutout in one of the connection components. Via the position of the operating lever, it is also possible for the setting of the switching device to be indicated.

The distribution unit may have on a side which faces toward the second connection component at least four openings for connection to the first and second fluid-guide pairs.

In an advantageous embodiment, that guide pair of the second connection component which is in each case not connected fluidically to the fluid guides of the first connection component is short-circuited. The second fluid-guide pair can consequently preferably be used as an oil oscillation line. The short circuit is preferably realized via a fluid guide in the distribution unit.

Preferably, two pressure hoses are mounted on the first connection component and/or four pressure hoses are mounted on the second connection component. The pressure hoses may be designed specifically for the position of the switching device and do not have to be configured for a routing arrangement or remounting.

In a preferred embodiment of the switching device, the position determination of the distribution unit is realized using a sensor. The sensor may for example be an optical, inductive or mechanical position sensor, or a pressure sensor which is arranged within the fluid guides. With the aid of the sensor, the position in which the distribution unit is, and possibly whether the distribution unit is in an undefined intermediate state, can be signalled to the operator.

The invention moreover relates to a concrete pump having a switching device. Via the switching device, the drive side of the hydraulically driven concrete pump can be transferred from the rod side to the bottom side.

The invention furthermore relates to a method for switching a hydraulic-medium flow of a concrete pump using a switching device, comprising the steps of:

releasing a fastening means, or resiliently mounted fastening element, arranged between the first and second connection components;

transferring a distribution unit between a first and a second position;

firmly tightening the fastening means or the resiliently mounted fastening element.

The method for switching a hydraulic-medium flow of a concrete pump makes possible a transfer of the drive side of the drive cylinder between rod side and bottom side using simple mechanical means and without cumbersome assembly work. During operation, the fastening means are to be tightened firmly, so that the switching device remains leak-proof and can withstand the high pressures prevailing in the fluid guides. During the transfer of the distribution unit, the latter requires a degree of play in order, for example, for a rotation or displacement to be carried out. However, the connection components should at all times act on the distribution unit such that no fluid can escape from the switching device.

The method according to the invention may be developed by way of further features described in conjunction with the switching device according to the invention. The switching device according to the invention may be developed by way of further features described in conjunction with the method according to the invention.

### BRIEF DESCRIPTION OF THE DRAWINGS

Advantageous embodiments of the invention will be described by way of example below on the basis of the appended figures. In the figures:

FIG. 1 shows a system-based circuit diagram for rod/bottom-switching using a switching device according to the invention in a first embodiment;

FIG. 2 shows a three-dimensional schematic illustration of a switching device according to the first embodiment;

FIG. 3 shows a three-dimensional schematic illustration of the switching device from FIG. 2 from another perspective;

FIG. 4 shows a schematic functional view of the switching device according to the first embodiment in a first position;

FIG. 5 shows a schematic functional view of the switching device from FIG. 4 in a second position;

FIG. 6 shows a three-dimensional schematic illustration of hydraulically driven drive cylinders of a concrete pump (not illustrated) with a switching device according to the first embodiment;

FIG. 7 shows a three-dimensional schematic view of a switching device according to the invention according to a second embodiment;

FIG. 8 shows a three-dimensional schematic illustration of hydraulically driven drive cylinders of a concrete pump (not illustrated) with a switching device according to the second embodiment;

FIG. 9 shows a schematic functional view of the switching device according to the second embodiment in a first position; and

FIG. 10 shows a schematic functional view of the switching device as per FIG. 9 in a second position.

### DETAILED DESCRIPTION

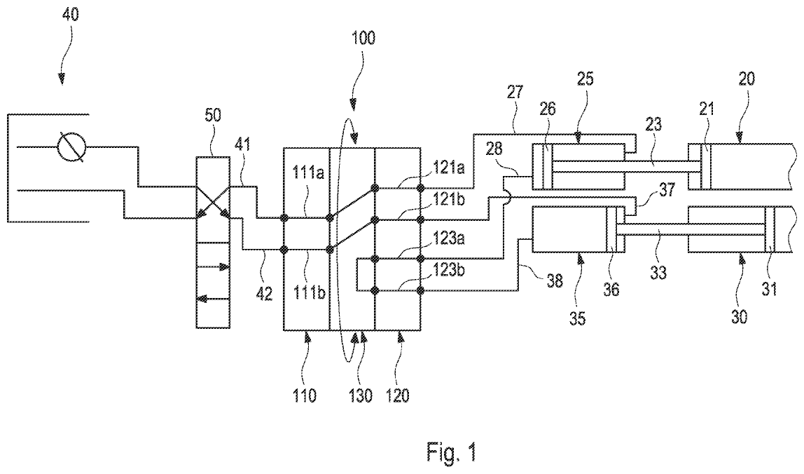

FIG. 1 shows a schematic circuit diagram of two hydraulically driven conveying cylinders 20, 30 of a concrete pump (not illustrated). This is preferably a stationary concrete pump. The pistons 21, 31 of the conveying cylinders 20, 30 are moved back and forth by way of hydraulic drive cylinders 25, 35, whose pistons 26, 36 are connected via piston rods 23, 33 to the pistons 21, 31 of the conveying cylinders 20, 30. The displacement of the pistons 26, 36 of the drive cylinders 25, 35 is realized by way of alternating charging with pressure medium of the piston rod-side pressure chambers of the drive cylinders 25, 35 via the illustrated pressure-medium lines 27, 37. Those pressure chambers of the drive cylinders 25, 35 which face toward the full surfaces of the pistons 26, 36 are connected by pressure-medium lines 28, 38 in the manner of a hydraulic linkage. All the pressure-medium lines 27, 37, 28, 38 are led through a switching device 100, which switching device is illustrated in a highly simplified form in FIG. 1 to make the arrangement thereof clear.

As is indicated in the symbolic illustration of the switching device 100, a distribution unit 130 which is arranged between a first and a second connection component 110, 120 can be set in two positions by way of rotation about its axis through 180°. In a first position (as per FIG. 1), the pressure-medium lines 27, 37 are connected to pressure-medium lines 41, 42 which serve for supply of pressure medium and for discharge of pressure medium, while the pressure-medium lines 28, 38 are connected to form a hydraulic linkage (rod-side operation). In a second position (not illustrated in FIG. 1), the pressure-medium lines 28, 38 are connected to the pressure-medium lines 41, 42 for supply and discharge of pressure medium, while the pressure-medium lines 27, 37 are connected to form a hydraulic linkage (bottom-side operation). A switching valve 50 may be provided for the alternating application of pressure and relief of pressure of the pressure-medium lines 41, 42. In the case of a mobile concrete pump having free-flow hydraulics (FFH) control, such a switching valve 50 is not required, however. A pressure-medium pump is denoted by the reference sign 40.

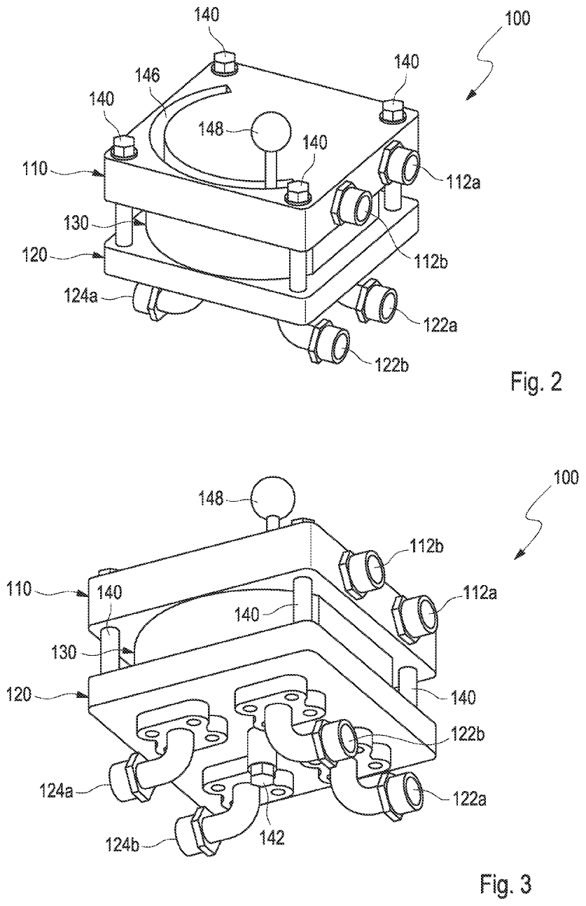

FIGS. 2-6 and 7-10 respectively illustrate in detail a first and a second exemplary embodiment of the switching device 100 and 200, respectively.

FIGS. 2 and 3 show a three-part switching device 100 according to a first embodiment from two different perspectives. The switching device 100 comprises a first connection component 110 and a second connection component 120. A distribution unit 130 is arranged between the connection components 110, 120. The distribution unit 130 is clamped in a sandwich-like manner between the connection components 110, 210. All three components of the switching device are formed so as to be substantially plate-like with side edges of equal length, this however not being in any way imperative.

The first connection component 110 has visibly on its outer side two ports for pressure hoses 112a, 112b, which are connected to fluid guides (not illustrated) within the first connection component 110. The second connection component 120 has on its outer side four ports for pressure hoses 122a, 122b, 124a, 124b with so-called threaded elbow joints, which are likewise connected to fluid guides (not illustrated) in the second connection component 120. The fluid guides of the first and second connection component 110, 120 are separated from one another by the distribution unit 130, as is described in more detail below.

In this embodiment, the switching device 100 has four fastening means 140 arranged in the corners that are in the form of screws. The fastening means 140 connect the first and second connection components 110, 120 to one another and can be tightened to such an extent that the distribution unit 130 is clamped in a secure or tight manner between the connection components 110, 120. The switching device 100 additionally has a centrally arranged, resiliently mounted fastening element 142. The fastening element 142 is designed as a combination of a screw and a spring and has the effect that, even after partial loosening of the fastening means 140, the first and second connection components 110, 120, by way of the force of the spring, continue to be pressed together. In this way, a fluid, such as a hydraulic medium, cannot undesirably escape from the switching device 100.

In order for the distribution unit 130 to be transferred from a first position into a second position, it is firstly necessary for the fastening means 140 to be loosened slightly, so that the distribution unit is no longer fixed between connection components 110, 120. The distribution unit 130 has an operating lever 148 on its side facing toward the first connection component 110. Instead of a mechanical actuation of the distribution unit 130, an electrical, hydraulic or pneumatic actuation is also possible. The operating lever 148 can be guided along a guide element 146 which is formed as part of one of the connection components 110, 120. By way of the movement of the operating lever 148 along the guide element 146, the distribution unit 130 can be rotated through up to 180°.

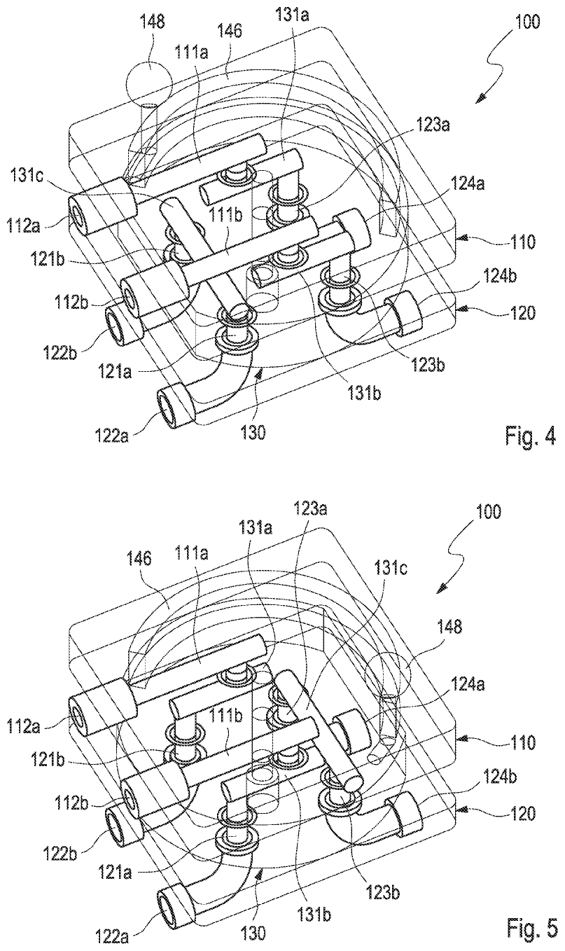

FIGS. 4 and 5 show the switching device 100 in a first position and a second position. The different orientation of the distribution unit 130 is indicated in particular by the different position of the operating lever 148 too. FIGS. 4 and 5 show the fluid guides arranged in the interior of the connection components 110, 120 and of the distribution unit 130. The first connection component 110 has fluid guides 111a and 111b which are connected to the ports for pressure hoses 112a, 112b. The second connection component 120 has four fluid guides 121a, 121b, 123a, 123b which are connected to the ports for pressure hoses 122a, 122b, 124a, 124b. The fluid guides 121a, 121b and 123a, 123b are in each case referred to as a fluid-guide pair. The fluid guides 111a, 111b, 121a, 121b, 123a, 123b extend as bores in the interior of the connection components 110, 120.

In this embodiment, the distribution unit 130 has three fluid guides 131a, 131b, 133c which, according to the position of the distribution unit 130, bring about fluid connections between different fluid guides of the first and second connection component 110, 120. In this exemplary embodiment, the fluid guides of the distribution unit are formed as bores which are suitable for transporting a pressure medium. In addition, the fluid guides 131a, 131b, 133c are equipped with sealing rings on the outer side of the distribution unit 130.

Fluid guide 131a of the distribution unit 130 connects fluid guide 122b of the first connection component 110 to fluid guide 123b of the second connection component 120. Fluid guide 131b of the distribution unit 130 connects fluid guide 112a of the first connection component 110 to fluid guide 123a of the second connection component 120. The fluid guides 123a, 123b belong to a fluid-guide pair. Fluid guide 131c connects the fluid guides 121a and 121b of the second connection component 120 and thereby short-circuits the fluid-guide pair 121a, 121b.

If an operator moves the operating lever 148 illustrated in FIG. 4 along the guide element 146 of the first connection component 110, the setting illustrated in FIG. 5 is obtained. In this case, the distribution unit 130 performs a rotation of 180° about its own axis. This central axis is determined in this embodiment by the resiliently mounted fastening element 142, which is guided through a cutout in the distribution unit 130. In this setting, the fluid guide 131c connects that fluid-guide pair of the second connection component 120 which is formed by the fluid guides 123a and 123b, while the fluid guides 131a and 131b each connect a fluid guide 112a, 112b of the first connection component 110 to a fluid guide 21a, 121b of the second connection component 120. Consequently, the transfer of the distribution unit 130 from the first position into the second position makes it possible to switch the type of operation between the fluid-guide pairs. In this way, an operator can switch the machine from rod-side operation to bottom-side operation, or from bottom-side operation to rod-side operation, without significant outlay in terms of assembly and in a short period of time.

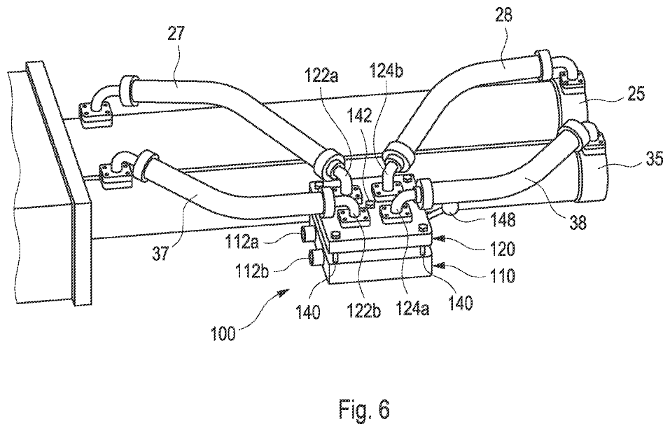

FIG. 6 shows the switching device 100 with fixedly connected pressure-medium lines 27, 37, 28, 38 in the form of pressure hoses. The pressure hoses connect the pressure-hose ports 122a, 122b, 124a, 124b of the second connection component 120 to the rod side or bottom side of the drive cylinders 25, 35 (see also FIG. 1), the structure of the switching device 100 otherwise being as described above. The switching device 100 may be arranged at any position of the machine, for example at any position along the drive cylinders 25, 35.

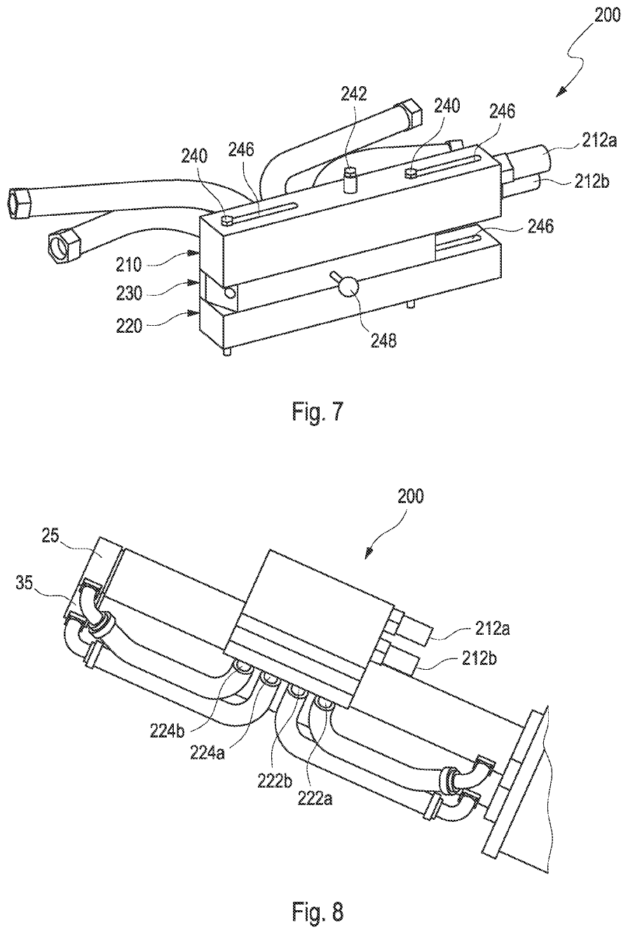

FIG. 7 shows a three-part switching device 200 according to a second exemplary embodiment of the invention. The switching device 200 comprises a first connection component 210, a second connection component 220 and a distribution unit 230 arranged between the first and second connection components 210, 220. The switching device 200 differs from the switching device 100 in that the reversible transfer of the distribution unit 230 between a first position and a second position is carried out by lateral displacement of the distribution unit 130. The displacement of the distribution unit 130 can likewise be realized via an operating lever 248.

The first and second connection components 210, 220 each have ports for pressure hoses 212a, 212b, 22a, 22b, 224a, 224b. The first and second connection components 210, 220 are moreover connected to one another via fastening means 240 in the form of screws and have in addition a resiliently mounted fastening element 242 in the form of a combination of a spring and a screw. The fastening means 240 are arranged in slots of the first and second connection component 210, 220, which slots serve as guide elements 246 during a displacement of the distribution unit 130. The distribution unit 230 is situated in the first and second positions in each case fully between the first and second connection components 210, 220 and is clamped therebetween.

FIG. 8 shows the switching device 200 with pressure hoses which are connected fixedly to the pressure ports 222a, 222b, 224a, 244b at the second connection plate 230. The pressure hoses connect the pressure ports 222a, 222b, 224a, 244b to the rod side or bottom side of the drive cylinders 25, 35. The switching device 200 may be arranged at any desired position at the machine, for example along the drive cylinders 25, 35.

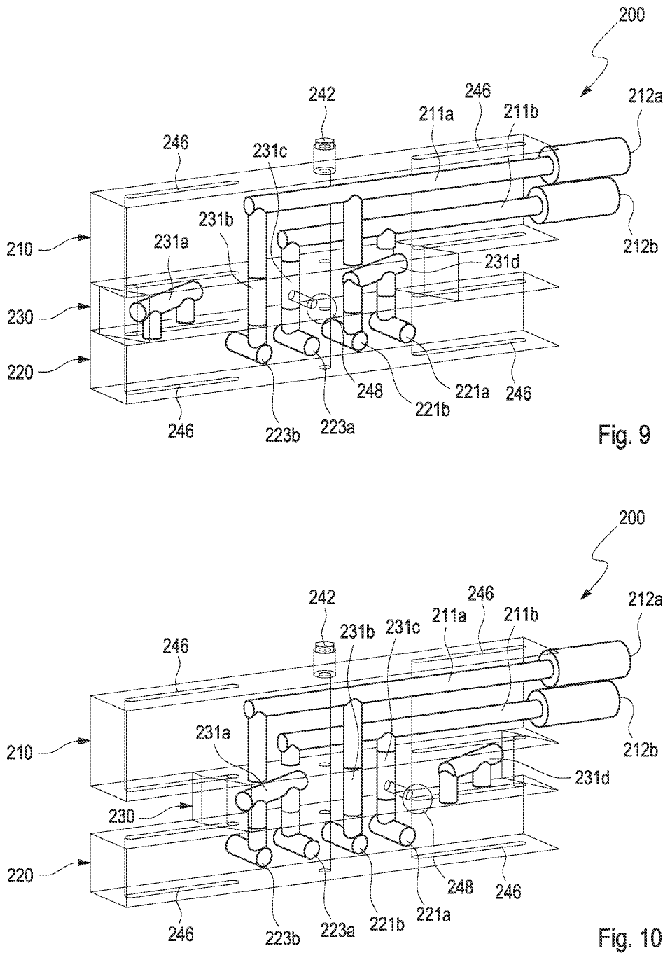

FIGS. 9 and 10 show the switching device 200 in a first position and a second position. The different position of the distribution unit 130 is characterized in that the distribution unit 130 is displaced in the direction of the pressure ports 212a, 212b in a substantially horizontal direction. In the setting shown in FIG. 9, a first fluid guide 211a of the first connection component 210 is connected via fluid guide 231b of the distribution unit 230 to fluid guide 223b of the second connection component 230, and a second fluid guide 211b of the first connection component 210 is connected fluidically via fluid guide 231c of the distribution unit 230 to fluid guide 223a of the second connection component 220. The fluid guides 221a and 221b of the second connection component 220 are both in contact with fluid guide 231d of the distribution unit 230 and are thereby short-circuited via the distribution unit 230 (hydraulic linkage). The fluid guides 223a and 223b belong to a fluid-guide pair.

In the setting illustrated in FIG. 10, the fluid guide 211a of the first connection component 210 is connected fluidically via the fluid guide 231b of the distribution unit 230 to fluid guide 221b of the second connection component 220. The second fluid guide 221b of the first connection component 210 is connected fluidically via fluid guide 231c of the distribution unit 230 to the fluid guide 221a of the second connection component 220. All the fluid guides are formed as bores, wherein the fluid guides 211a, 211b of the first connection component have branches with multiple mutually offset exits. This, however, is not a problem since the connection components 210, 220 are, via the resiliently mounted fastening element 240 and any seal elements (not illustrated), at all times held together in such a way that the switching device 200 is leak-tight.

For carrying out the method for switching a hydraulic flow of a concrete pump by way of a switching device 100, 200, firstly the fastening means 140, 240 (or the resiliently mounted fastening element 142, 242) are (is) unscrewed slightly, without however releasing the connection between the first and second connection components 110, 120, 210, 220. This enables the distribution unit 130, 230 to have a sufficient amount of play to allow a rotation or translation between the connection components. As soon as the final position of the distribution unit 230 has been reached, the fastening means 140, 240 (or the resiliently mounted fastening element) are (is) screwed tight again by an operator before the switching device 100, 200 can be used during operation.

1. A switching device for switching a hydraulic flow of a concrete pump, comprising
a first connection component for connection to a hydraulic pump;
a second connection component for connection to a drive cylinder; and
a distribution unit which is arranged between the first and second connection components,
wherein the first connection component has two fluid guides and the second connection component has a first fluid-guide pair and a second fluid-guide pair, and
the distribution unit can be transferred reversibly between a first position, in which the fluid guides of the first connection component are connected fluidically to the first fluid-guide pair of the second connection component, and a second position, in which the fluid guides of the first connection component are connected fluidically to the second fluid-guide pair of the second connection component, wherein the distribution unit is connected in a leak-tight manner to the first and second connection components.

2. The switching device of claim 1, wherein the distribution unit can be transferred between the first and second positions by way of rotation or translation.

3. The switching device of claim 1, wherein, when the distribution unit is transferred between the first and second positions, a position of the first and second connection components remains unchanged.

4. The switching device of claim 1, wherein the distribution unit has a first sealing surface for interaction with a sealing surface of the first connection component and/or has a second sealing surface for interaction with a sealing surface of the second connection component.

5. The switching device of claim 1, wherein the first and second connection components are connected to one another in a resilient manner.

6. The switching device of claim 1, wherein the first and second connection components are connected to one another via at least one releasable fastening means.

7. The switching device of claim 6, wherein the first and second connection components are connected to one another in such a way that no fluid can escape between the first or second connection component and the distribution unit when the at least one releasable fastening means is released.

8. The switching device of claim 1, wherein the first and second connection components are connected to one another via a resiliently mounted fastening element in such a way that the distribution unit is connected in a leak-tight manner to the first and second connection components.

9. The switching device of claim 6, wherein the fastening means and/or the resiliently mounted fastening element are/is configured as a guide aid for the transfer of the distribution unit between the first and second positions.

10. The switching device of claim 1, wherein the first and/or second connection component has a guide element for the transfer of the distribution unit between the first and second positions.

11. The switching device of claim 1, wherein the distribution unit has an operating lever for the transfer between the first and second positions, the operating lever preferably interacting with a guide element of the first or second connection component.

12. The switching device of claim 1, wherein the distribution unit has on a side which faces toward the second connection component at least four openings for connection to the first and second fluid-guide pairs.

13. The switching device of claim 1, wherein that fluid-guide pair of the second connection component which is in each case not connected fluidically to a fluid guide of the first connection component is short-circuited.

14. The switching device of claim 1, wherein two pressure hoses are mounted on the first connection component and/or four pressure hoses are mounted on the second connection component.

15. The switching device of claim 1, wherein the position determination of the distribution unit is realized using a sensor.

16. A concrete pump having a switching device of claim 1.

17. A method for switching a hydraulic-medium flow of a concrete pump using a switching device of claim 1, comprising the following steps:
releasing a fastening means or resiliently mounted fastening element arranged between a first and a second connection component;
transferring a distribution unit between a first and a second position;
firmly tightening the fastening means or the resiliently mounted fastening element.
